(19) United States
(12) Patent Application Publication
(10) Pub. No.: US 2019/0092409 A1
(43) Pub. Date: Mar. 28, 2019

(54) CYCLING SADDLES WITH CONCAVE FEATURES FOR SUPPORTING PELVIC ANATOMY

(71) Applicant: Edge Cycling Technologies LLC, Xenia, OH (US)

(72) Inventors: Shane M. Page, Xenia, OH (US); John G. Massengale, Xenia, OH (US); Evan J. Price, Xenia, OH (US); Nicholas Allan Price, Xenia, OH (US)

(21) Appl. No.: 16/040,117

(22) Filed: Jul. 19, 2018

Related U.S. Application Data
(60) Provisional application No. 62/562,068, filed on Sep. 22, 2017.

(51) Int. Cl. B62J 1/00

(52) U.S. Cl. CPC B62J 1/007; B62J 1/18; B62J 1/002

(57) ABSTRACT

Cycling saddles have an elongated front portion, a seat portion, a pair of individual side indentations, and optionally a longitudinal depression. The optional longitudinal depression is defined in the top surface from the elongated front portion to a rear slope of the seat portion. The individual side indentations are defined in the top surface and laterally offset within the seat portion on opposite sides of the seat portion. The combination of the seat portion, the pair of individual side indentations, and the optional longitudinal depression alleviates various pressure points on the pelvic anatomy of an operator positioned or seated on the cycling saddle, particularly with respect to ischial tuberosities and various neurovasculature structures. Additional benefits may be realized if the seat portion is concave, such that a top surface of the cycling saddle within the seat portion is depressed relative to the elongated front portion and the rearward end.

### CROSS REFERENCES TO RELATED APPLICATIONS

This application claims the benefit of priority to U.S. Provisional Application Ser. No. 62/562,068, filed Sep. 22, 2017, which application is incorporated by reference herein in its entirety.

### TECHNICAL FIELD

The present disclosure relates generally to cycling saddles and, more specifically, to cycling saddles having concave features for alleviating pressure points to the pelvic anatomy.

### BACKGROUND

For recreational and competitive cycling, performance and endurance of a rider can be extremely limited by pain or other physical ailment brought about by pressure imposed upon the anatomy of the rider, particularly on the pelvic anatomy. Though conventional cycling saddles accomplish some degrees of comfort by adding features such as soft padding in various locations, the conventional cycling saddles at best tend to mitigate the types of contact that result in pressure points on the rider's anatomy. Accordingly, there remain ongoing needs for cycling saddles that include structures and design considerations that can minimize or even eliminate pressure points against a rider's pelvic anatomy.

### SUMMARY

Embodiments of this disclosure include cycling saddles having an elongated front portion, a seat portion, a pair of individual side indentations, and optionally a longitudinal depression. The elongated front portion is between a forward end of the cycling saddle and a saddle inflection of the cycling saddle. The seat portion is between the saddle inflection and a rearward end of the cycling saddle opposite the forward end. The pair of individual side indentations are defined in the top surface and laterally offset within the seat portion on opposite sides of the seat portion. The individual side indentations are configured to accommodate ischial tuberosities of an operator positioned on the top surface. When present, the longitudinal depression may be defined in the top surface from the elongated front portion to the rear slope. In some embodiments, the seat portion may be concave, such that a top surface of the cycling saddle within the seat portion is depressed relative to the elongated front portion and the rearward end and such that the top surface includes a front slope descending from the saddle inflection toward the rearward end and a rear slope descending from the rearward end toward the front slope. The combination of the seat portion, the pair of individual side indentations, and the optional longitudinal depression alleviates various pressure points on the pelvic anatomy of an operator positioned or seated on the cycling saddle. The alleviation of the various pressure points may be further enhanced when the seat portion is concave.

Additional features and advantages of the embodiments described herein will be set forth in the detailed description which follows, and in part will be readily apparent to those skilled in the art from that description or recognized by practicing the embodiments described herein, including the detailed description which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIG. 1 is a perspective view of a cycling saddle according to embodiments of the present disclosure.

FIG. 2 is top plan view of the cycling saddle of FIG. 1.

FIG. 3 is a rear partial elevational view of the cycling saddle of FIG. 1.

FIG. 4 is a front elevational view of the cycling saddle of FIG. 1.

FIG. 5 is a bottom plan view of the cycling saddle including multiple fitments for securing the cycling saddle to a rail support system.

FIG. 6 is a side elevational view of the cycling saddle including a front portion having a downward tilt angle relative to a rear portion.

FIG. 7 is a side elevational view of the cycling saddle including a rail support system along a bottom surface opposite of the top surface.

FIG. 8 is a schematic illustration of a human pelvic skeletal anatomy.

FIG. 9 is a rear schematic illustration of the human pelvic skeletal anatomy positioned atop the top surface of the cycling saddle with the ischial tuberosities of the skeletal anatomy received within side indentations of the cycling saddle.

FIG. 10 is a side schematic illustration of the human pelvic skeletal anatomy positioned atop the top surface of the cycling saddle, with the ischial tuberosity received within the side indentation.

FIG. 11 is a perspective view of another cycling saddle having a pair of elongated side indentations extending along a top surface according to embodiments of the present disclosure.

FIG. 12 is a side elevational view of the cycling saddle of FIG. 11 having a front portion with a downward tilt angle relative to a rear portion.

### DETAILED DESCRIPTION

Embodiments of this disclosure are directed to cycling saddles having features for supporting pelvic anatomy and thereby alleviating pressure points commonly associated with riding a cycle on which a cyclist is seated. The cycling saddles are suitable for use with vehicles such as, but not limited to, bicycles, unicycles, or tricycles, for example. It should be understood, however, the features of the cycling saddles for supporting pelvic anatomy may have broader applicability to any type of seat on which a person intends to be seated for an extended period of time, including seats for furniture that may not be connected with any type of moving vehicle. Therefore, though the term “cycling saddle” may be used throughout this disclosure, it should be understood that the uses of the cycling saddle do not necessarily require the cycling saddle to be connected with or used with a moving vehicle.

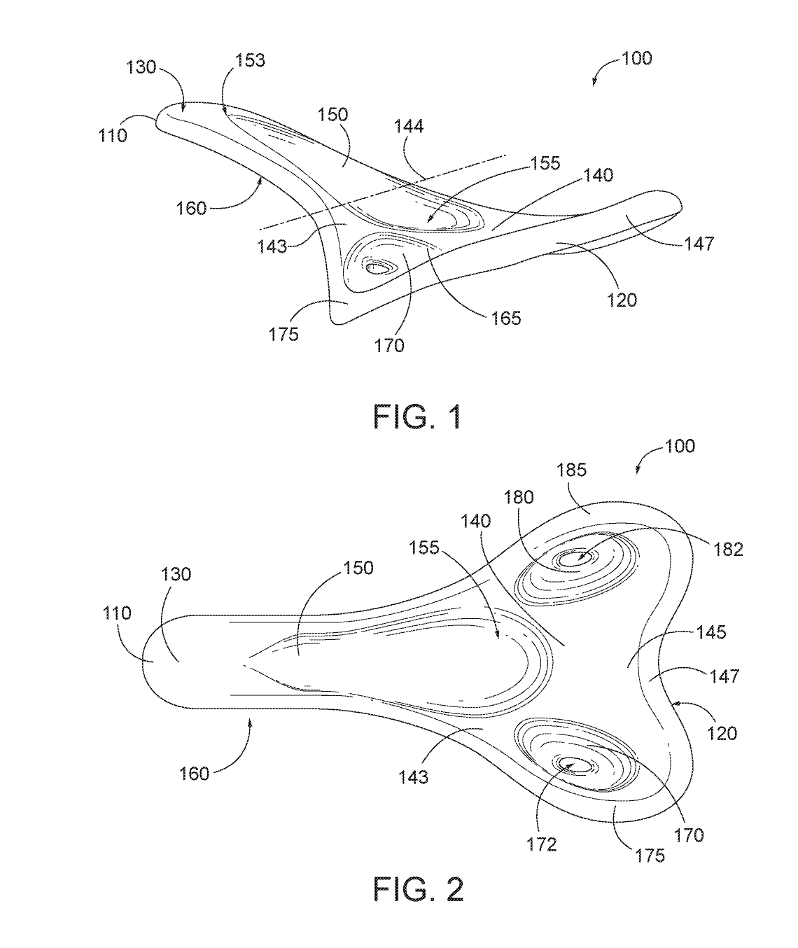

Referring to FIGS. 1-4, in an example embodiment, a cycling saddle 100 includes an elongated front portion 160 between a forward end 110 of the cycling saddle 100 and a saddle inflection 144 of the cycling saddle 100. The cycling saddle 100 includes a seat portion 140 between the saddle inflection 144 and a rearward end 120 of the cycling saddle 100 opposite the forward end 110. The front slope 143 of the seat portion 140 intersects with the elongated front portion 160 at the saddle inflection 144.

In some embodiments, the seat portion 140 may be concave. When the seat portion 140 is concave, a top surface 130 of the cycling saddle 100 within the seat portion 140 is depressed relative to the elongated front portion 160 and the rearward end 120, such that the top surface 130 includes a front slope 143 descending from the saddle inflection 144 toward the rearward end 120 and a rear slope 145 descending from the rearward end 120 toward the front slope 143.

The cycling saddle 100 further includes a pair of individual side indentations 170, 180 defined in the top surface 130 and laterally offset within the seat portion 140 on opposite sides of the seat portion 140. As will be described subsequently in greater detail, the individual side indentations 170, 180 are configured to accommodate the pelvic anatomy, specifically the ischial tuberosities, of an operator positioned or seated on the top surface 130 of the cycling saddle 100, even as the operators' weight is shifted from side to side during a pedaling motion.

Still referring to FIGS. 1-4, the top surface 130 of the cycling saddle 100 may include a longitudinal depression 150 defined therein. The longitudinal depression 150 may be a single depressed area in the top surface 130 of the cycling saddle 100 longitudinally defined from a depression front 153 in the elongated front portion 160, across the saddle inflection 144, to a depression rear 155 adjacent to the rear slope 145 in the seat portion 140. The top surface 130 of the cycling saddle 100 may include a back ridge 147 along the rearward end 120 that is sized and shaped to provide additional support to an operator positioned or seated on the cycling saddle 100. In some embodiments, the back ridge 147 may be raised with respect to the rear slope 145.

As in the embodiment of FIGS. 1-4, the side indentations 170, 180 optionally may include an aperture 172, 182 positioned along a center of each side indentation 170, 180 respectively. The apertures 172, 182 may facilitate fabrication of the cycling saddle 100 by a molding process such as injection molding. It should be understood, therefore, that in other versions apertures 172, 182 may be sized and shaped differently than in the embodiment of FIGS. 1-4, or that apertures 172, 182 may be omitted entirely from within the side indentations 170, 180.

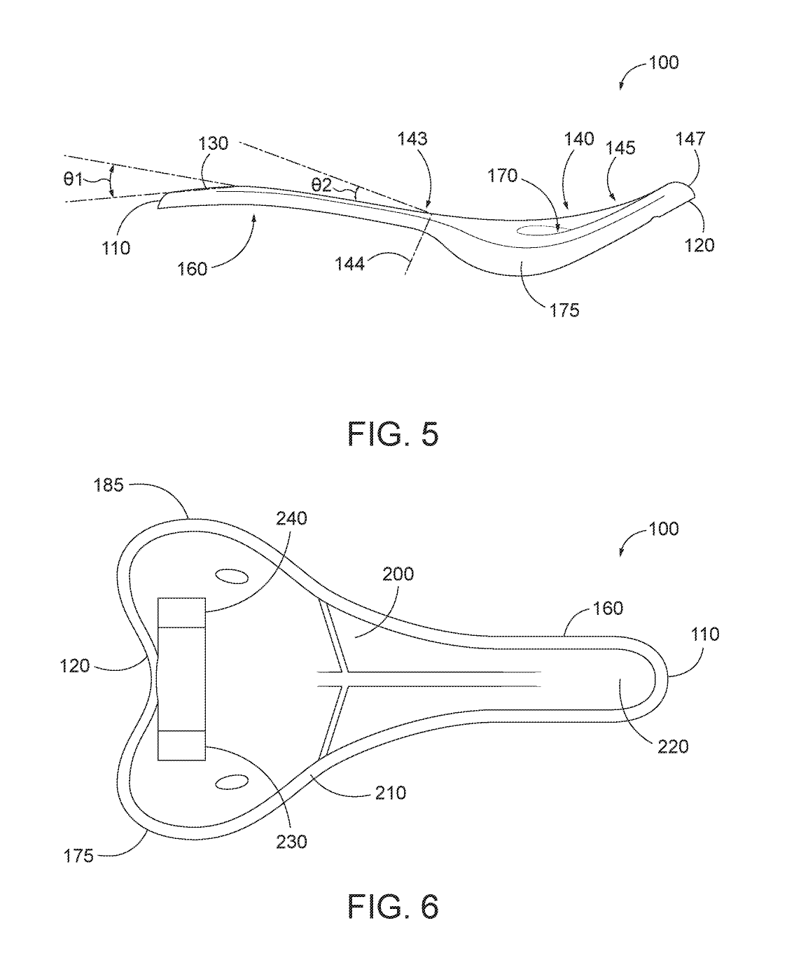

Referring to FIG. 5, as previously described, the saddle inflection 144 represents the meeting of the elongated front portion 160 and the front slope 143 of the seat portion 140. In some embodiments, particularly when the seat portion 140 is concave, a curvature of the top surface 130 at the saddle inflection 144 provides a slight anterior or forward tilt of the elongated front portion 160 relative to the front slope 143. This curvature may be defined by an angle θ₂ of from about 5° to about 20°, or from about 5° to about 10°. The slight anterior or forward tilt of the elongated front portion 160 may facilitate accommodation of the pelvic anatomy of an operator positioned or seated on the top surface 130 of the cycling saddle 100. It should be understood that the angle θ₂ may also be greater than 20° or less than 5° in some embodiments, so as to maintain a concave profile or contour to the seat portion 140 retains through both a front slope 143 and a rear slope 145. Optionally, the elongated front portion 160 adjacent to the forward end 110 may include a second downward tilt relative to the remainder of elongated front portion 160 extending from the saddle inflection 144, the second downward tilt being defined relative to an angle θ₁ of from about 5° to about 25° or from about 10° to about 25°, or from about 10° to about 20°. The second downward tilt defined by angle θ₁ may facilitate an operator's ability to learn forward while positioned or seated on the top surface 130 of the cycling saddle 100.

Referring again to FIGS. 1-4, as previously described, the cycling saddle 100 further includes a pair of side indentations 170, 180 positioned within the seat portion 140 and adjacent to the rearward end 120. The pair of side indentations 170, 180 include a left indentation 170 and a right indentation 180 defined in the top surface 130 adjacent to a left outer edge 175 and a right outer edge 185 of the top surface 130, respectively. In particular, the left indentation 170 may be an ovoid depression defined in the seat portion 140 adjacent to the left outer edge 175 of the top surface 130, such that the left indentation 170 is laterally offset from the longitudinal depression 150. Similarly, the right indentation 180 may be an ovoid depression defined in the top surface 130 adjacent to a right outer edge 185 of the top surface 130, such that the right indentation 180 is laterally offset from the longitudinal depression 150 opposite the left indentation 170. The ovoid depression of the left indentation 170 is partially defined by a left side slope 165 between the left indentation 170 and the rear slope 145. Similarly, the depression of the right indentation 180 is partially defined by a right side slope 167 extending between the right indentation 170 and the rear slope 145. The term “ovoid depression” may be understood as “generally resembling the shape of an egg” or, more precisely, as “generally resembling the shape of an egg sliced through a rotational axis of symmetry of the egg.” It should be understood that the term “ovoid” is not intended to limit the shape of the ovoid depression to the precise shape of any particular egg. The shape of an egg typically includes a long portion joined to a short portion, where the long portion is a prolate spheroid and the short portion is a nearly spherical ellipsoid or oblate spheroid. Furthermore, the left indentation 170 and the right indentation 180 defined in the top surface 130 are distinguished at least in part in that they are merely depressed areas in the top surface 130, not holes extending entirely through the cycling saddle 100. Though apertures 172, 182 optionally may be present in the indentations 170, 180 for facilitating fabrication of the cycling saddle 100 by a molding process such as injection molding, the indentations 170, 180 themselves otherwise do not open to the bottom surface 200 (FIG. 6) of the cycling saddle 100.

In embodiments, the left indentation 170 and the right indentation 180 may be inwardly slanted, such that the frontward-facing ends of the left indentation 170 and the right indentation 180 point toward the longitudinal center of the cycling saddle 100. As will be described in greater detail below, the left side slope 165 and the right side slope 167 of indentations 170, 180 are configured and operable to accommodate the pelvic anatomy of an operator seated on the cycling saddle 100.

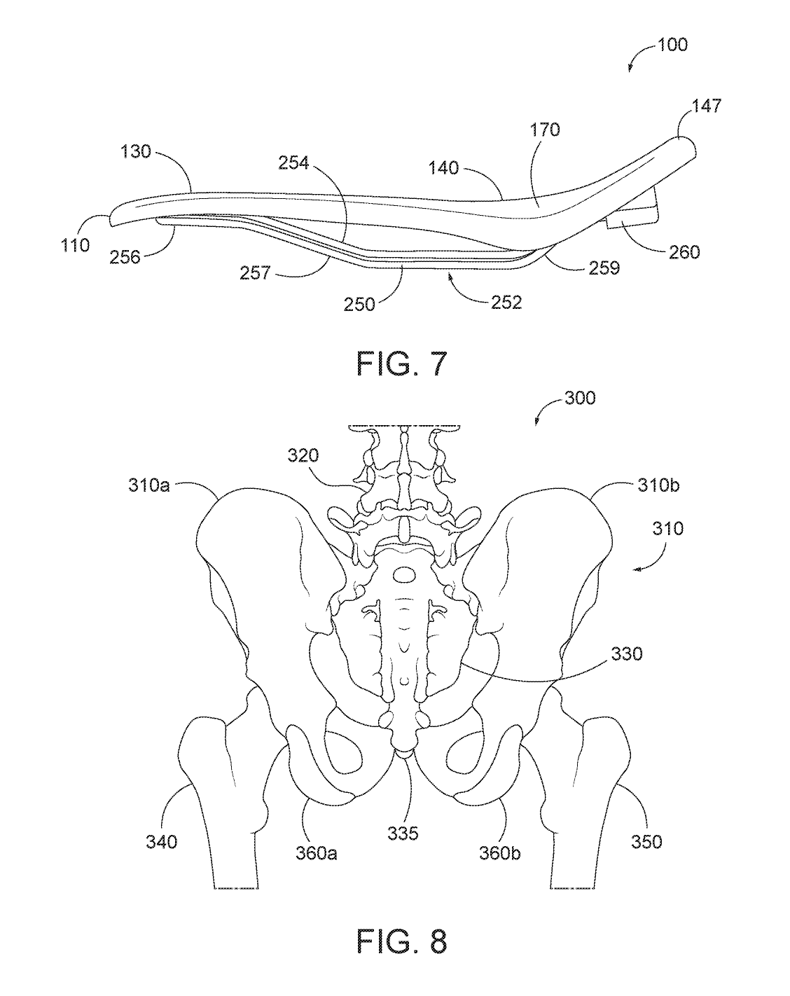

Referring to FIGS. 6 and 7, a bottom surface 200 of the cycling saddle 100 may include a framing portion 210 around outer edges 175, 185 of the cycling saddle 100. In the present example, the bottom surface 200 includes a front fitment 220, a left fitment 230, and a right fitment 240, into which rail supports 250 (see FIG. 7) may be inserted for mounting the cycling saddle 100 to a framing member of a vehicle (not shown) such as a bicycle, for example. Accordingly, the fitments 220, 230, 240 may be coupled to rail supports 252 adapted to facilitate connection of the cycling saddle 100 to the vehicle. In particular, the rail supports 252 may include a left rail 250 and a right rail 254. In the present example, both the left rail 250 and the right rail 254 include a front insertion member 256, a front angled portion 257, a rear angled portion 259, and a rear insertion member 260. In this instance, the front insertion members 256 of the rails 250, 254 may be inserted into the front fitment 220 along the bottom surface 200 of the cycling saddle 100. Similarly, the left rail 252 may be inserted into the left fitment 230 and the right rail 254 may be inserted into the right fitment 240 along the bottom surface 200 of the cycling saddle 100. It should be understood that in addition to the configuration of the rail supports 252 and the fitments 220, 230, 240 described and shown herein, the cycling saddle 100 may include any suitable mounting system known in the art for mechanically coupling a cycling saddle to a vehicle, provided the cycling saddle 100 retains other features described herein for alleviating pressure points on the pelvic anatomy of an operator positioned or seated on the cycling saddle 100.

When the cycling saddle 100 is mounted on a vehicle such as by rail supports 252 as previously described, the cycling saddle 100 may be mounted at any angle of tilt preferred by the operator of the vehicle. In some instances, the cycling saddle 100 may be mounted on the vehicle to include a forward tilt maximizing the benefits of the cycling saddle 100 to alleviate pressure points on the pelvic anatomy, whereby, for example, the entirety of the cycling saddle 100 may be rotated forward about the saddle inflection 144 (see FIG. 1) by from 0° to 10° or from 3° to 10° in a manner that raises the rearward end 120 of the cycling saddle. Such a slight forward tilt may, in turn, provide greater relief to the operator from pressure points on pelvic anatomy.

To illustrate particular benefits of the cycling saddle 100 according to embodiments for relieving pressure points, FIG. 8 shows a human pelvic anatomy 300 including a pelvic girdle 310 comprising a left ilium 310a, a right ilium 310b, a spinal column 320, and a sacrum 330 at the end of the spinal column 320. The human pelvic anatomy 300 further includes a coccyx 335 at the end of the sacrum 330, a left femur 340 at the end of the left ilium 310a, and a right femur 350 at the end of the right ilium 310b. The human pelvic anatomy 300 includes also a pair of ischial tuberosities 360a, 360b located at the bottom of the pelvic girdle 310. For average humans, the distance between ischial tuberosities typically ranges from about 100 mm to about 150 mm. Precise distances for a particular person may be measured by seating the person on an in-printable surface such as corrugated cardboard or memory foam to produce indentations in the surface, then measuring the distance between the centers of the indentations). For the cycling saddle 100 according to some embodiments, the configuration, shapes, and sizes of the side indentations 170, 180 may be such that all average humans, regardless of age and size, may benefit from the pressure relief afforded by the side indentations 170, 180. According to other embodiments of the cycling saddle 100, the configuration, shapes, and sizes of the side indentations 170, 180 may be customized and optimized based on a precise measurement of the intended rider's ischial tuberosities.

It should be understood that, when an operator sits on a conventional seat, including conventional bicycle saddles, a substantial portion of the operator's weight is positioned against and rests upon the ischial tuberosities 360a, 360b of the pelvic girdle 310. Accordingly, during extended periods of sitting on a conventional seat, such as during the riding of a bicycle, for example, continued pressure on the ischial tuberosities 360a, 360b may produce considerable discomfort to the operator. As merely an illustrative example, in the example of the seat being that of a bicycle, an operator seated on a conventional bicycle seat for a prolonged period may experience substantial pain that may adversely affect the operator's stamina or endurance.

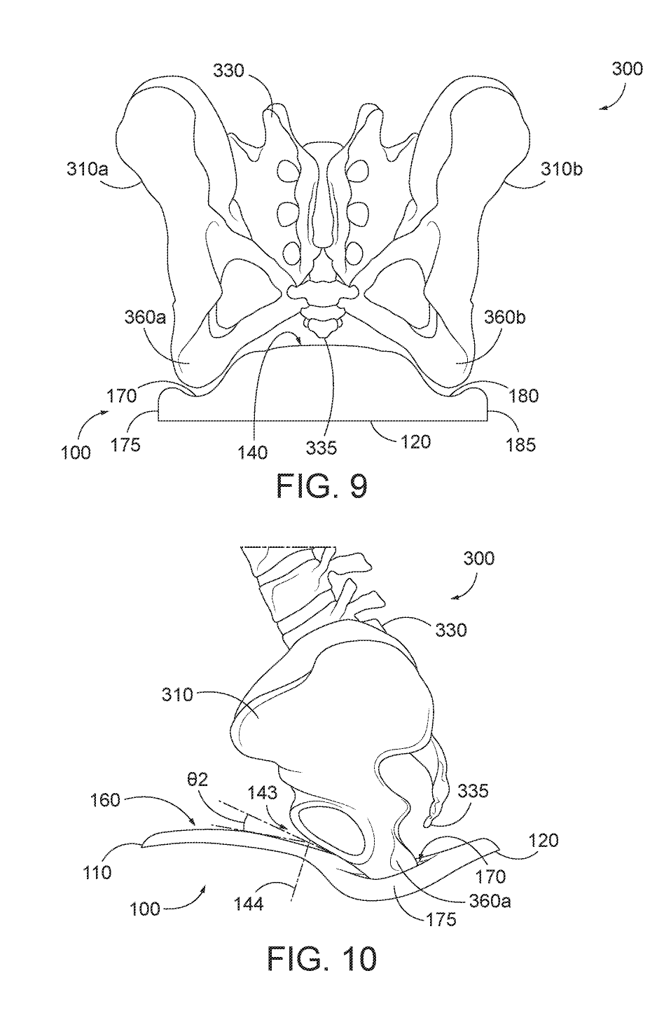

Various benefits of the cycling saddle 100 according to embodiments of this disclosure are evident in FIGS. 9 and 10. In particular, FIG. 9 shows the typical position of the human pelvic anatomy 300 of an operator positioned on the top surface 130 of the cycling saddle 100. Particularly, the ischial tuberosities 360a, 360b of the operator are received within the left indentation 170 and the right indentation 180 of the cycling saddle 100. The size and contours of the left indentation 170 and the right indentation 180 cause the ischial tuberosities 360a, 360b to be cradled within the indentations 170, 180, whereby the downward force from the weight of the operator against cycling saddle 100 is spread over a much larger surface area of the ischial tuberosities 360a, 360b than would occur if the indentations 170, 180 were not present. Particularly when the seat portion 140 is concave, the coccyx 335 at the end of the sacrum 330 of the human pelvic anatomy 300 as well as other ligamentous and soft tissue structures (not shown) are cradled within the seat portion 140. Specifically, the concavity of a seat portion 140 that is concave provides clearance between the ligamentous and soft tissue structures and coccyx 335 and the top surface 130 of the cycling saddle 100. Accordingly, the side indentations 170, 180 and the seat portion 140 of the cycling saddle 100 are configured and operable to relieve the pressure points at the ischial tuberosities 360a, 360b and the coccyx 335 and the various ligamentous and soft tissue structures of the operator's human pelvic anatomy 300 such that the potential for pain or discomfort from being seated atop the top surface 130 is effectively alleviated.

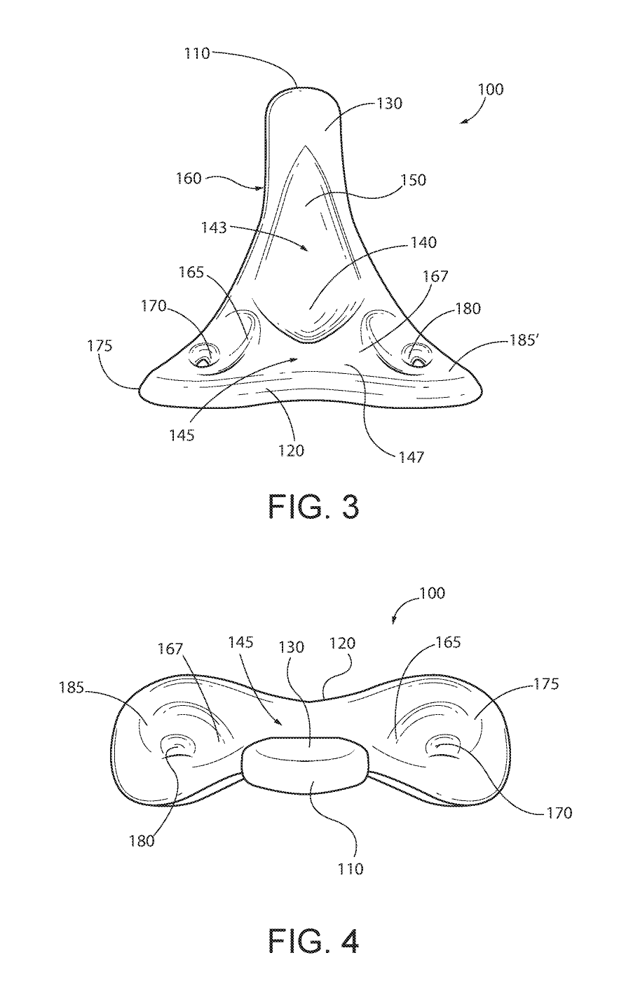

Further benefits of the cycling saddle 100 according to embodiments are evident from the side illustration of FIG. 10. When a vehicle such as a bicycle is in motion through the operator's actions (pedaling, for example), the human pelvic anatomy 300 of the operator seated on the top surface 130 may be positioned in a forward-leaning orientation relative to the cycling saddle 100. In this instance, despite the forward lean of the human pelvic anatomy 300 (as is common when aggressively and/or competitively riding a bicycle) the left ischial tuberosity 360a is adequately cradled within the left indentation 170 due to the gradually-inclined clearance formed within the left indentation 170 by the left side slope 165 (see FIG. 3). Similarly, the right ischial tuberosity 360b is comfortably received within the right indentation 180 due to the sloped depression formed within the right indentation 180 by the right side slope 167 (see FIG. 3).

The left indentation 170 and the right indentation 180 function together when the operator is seated on the top surface 130 and independently of each other in a synergistic manner when the operator is moving, such as by pedaling a bicycle. When the operator is seated, such as when a bicycle or other vehicle is stopped or during coasting without pedaling, the left indentation 170 accepts the left ischial tuberosity 360a and right indentation 180 accepts the right ischial tuberosity 360b. When the operator is moving, such as during pedaling, in an alternating manner the left indentation 170 accepts and cushions primarily the left ischial tuberosity 360a, then the right indentation 180 accepts and cushions the right ischial tuberosity 360b, as a result of the operator's weight being shifted from side to side with the pedaling motion and propulsion of the bicycle or other vehicle. Additionally, when the seat portion 140 is concave, the front slope 143 of the seat portion 140 at the saddle inflection 144 at angle θ₂ relative to the elongated front portion 160 provides ample clearance for neurovascular structures contained in the Alcocks Canal (not shown) of the human pelvic anatomy 300, thereby avoiding rubbing or pressure against such structures, despite the forward-leaning orientation of the operator. Thereby, the curvatures of the cycling saddle 100 provide the operator additional freedom to lean forward during aggressive riding, without the risk of painful pressure points.

Similarly, when the seat portion 140 is concave, the back slope 145 of the seat portion 140 is contoured in a manner that includes a gradual upward slope that tapers off at a back ridge 147 with no sharp angles. Thereby, the seat portion 140 when concave further functions as a cupping mechanism that provides pressure relief to the sacrum 330, and specifically to neurovascular and ligamentous structures (not shown) that exit the sacrum 330 and that are typically compressed from the convex surface of a conventional bicycle saddle, even when the conventional bicycle saddle includes soft padding in the same areas. When the seat portion 140 is concave, the concave curvature of the seat portion 140 from the back ridge 147 to the saddle inflection 144, in combination with the gradual tapering of the top surface 130 into the longitudinal depression 150 along the front slope 143, provide a continuous valley or depression that naturally conforms to size and shape of the sacrum 330 and surrounding musculature and various other soft tissue (not shown) of the human pelvic anatomy 300. In particular, the continuous valley or depression formed by the seat portion 140 and the longitudinal depression 150 may allow an operator to sit on the top surface 130 of the cycling saddle 100 without experiencing increased pressure onto the posterior ligaments and surrounding soft tissue (not shown) of the sacrum 330, such as the sacrotuberous ligaments, the sacrospinalis ligaments, and gluteus musculature, which commonly cause pudendal neuralgia.

Additionally, the longitudinal depression 150 that extends from the seat portion 140 to the elongated front portion 160 may further minimize pressure on the Alcocks Canal (not shown) of the human pelvic anatomy 300, which include neurovascular structures that supply blood flow and nerve impulses to the genitalia of the operator. In combination, the curvature of the seat portion 140 (particularly when the seat portion 140 is concave) the presence of the longitudinal depression 150, and the presence of the side indentations 170, 180 along the top surface 130 of the cycling saddle 100, act synergistically to provide comfort to an operator positioned or seated on the cycling saddle 100 by minimizing multiple potential pressure points on the human pelvic anatomy 300 that are common in conventional seats, such as bicycle seats.

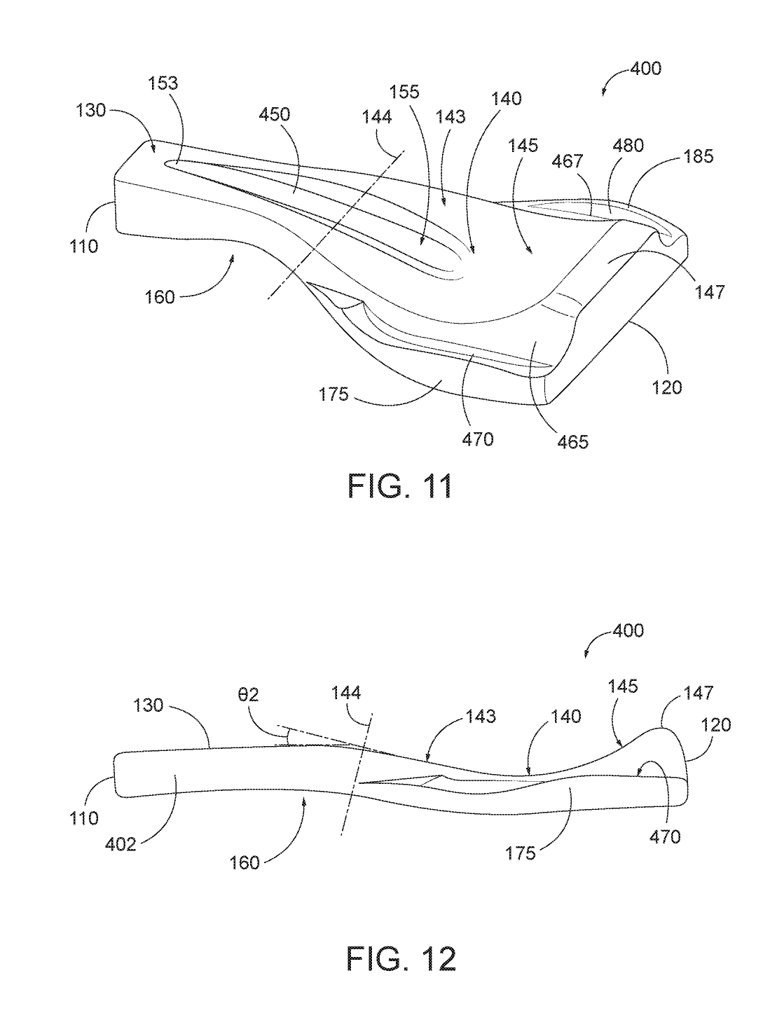

An additional embodiment of a cycling saddle 400 will now be described with reference to FIGS. 11 and 12. In the example shown, it should be understood that the cycling saddle 400 is substantially similar to the cycling saddle 100 previously described with reference to FIGS. 1-7. Accordingly, like reference numerals are used to identify like components. Further, it should be understood that the cycling saddle 400 of this example may be configured in the same manner and be similarly operable to the cycling saddle 100 previously described, except with regard to various differences that will be described.

The cycling saddle 400 includes an elongated front portion 160 between a forward end 110 of the cycling saddle 400 and a saddle inflection 144 of the cycling saddle 400. The cycling saddle 400 includes a seat portion 140 between the saddle inflection 144 and a rearward end 120 of the cycling saddle 100 opposite the forward end 110. The cycling saddle 400 further includes a pair of individual side indentations 470, 480 defined in the top surface 130 and laterally offset within the seat portion 140 on opposite sides of the seat portion 140. The individual side indentations 470, 480 are configured to accommodate the pelvic anatomy of an operator positioned or seated on the top surface 130 of the cycling saddle 100.

As in the embodiment of FIGS. 11 and 12, the seat portion 140 of the cycling saddle 400 may be concave. A top surface 130 of the cycling saddle 400 within the seat portion 140 may be depressed relative to the elongated front portion 160 and the rearward end 120, such that the top surface 130 includes a front slope 143 descending from the saddle inflection 144 toward the rearward end 120 and a rear slope 145 descending from the rearward end 120 toward the front slope 143. The front slope 143 of the seat portion 140 intersects with the elongated front portion 160 at the saddle inflection 144.

The top surface 130 of the cycling saddle 400 may include a longitudinal depression 150 defined therein. The longitudinal depression 150 may be a single depressed area in the top surface 130 of the cycling saddle 400 longitudinally defined from a depression front 153 in the elongated front portion 160, across the saddle inflection 144, to a depression rear 155 adjacent to the rear slope 145 in the seat portion 140. The top surface 130 of the cycling saddle 400 may include a back ridge 147 along the rearward end 120 that is sized and shaped to provide additional support to an operator positioned or seated on the cycling saddle 400. In some embodiments, the back ridge 147 may be raised with respect to the rear slope 145.

In the cycling saddle 400, the individual side indentations 470, 480 are configured as valleys or grooves along the outer edges 175, 185 of the top surface 130 from the rearward end 120 toward the saddle inflection 144. Similarly to the side indentations 170, 180 of the cycling saddle 100 described with reference to FIGS. 1-5, the side indentations 470, 480 are sized and shaped to receive the ischial tuberosities 360a, 360b of the human pelvic anatomy of an operator positioned or seated on the cycling saddle 400. In the present example, the side indentations 170, 180 include side slopes 465, 467 from the lowest point of the side indentations 470, 480 toward the top surface 130. Referring to FIG. 11, the top surface 130 includes an elongated front portion 160 having a tapered longitudinal depression 450. In the present example, the tapered longitudinal depression 450 includes a narrow profile or width at the depression front 153 adjacent to the forward end 110 and has a wider relative profile along the depression middle portion 155. Similar to the longitudinal depression 150 of the cycling saddle 100 described with reference to FIGS. 1-5 the tapered longitudinal depression 450 extends into the seat portion 140 such that the tapered longitudinal depression 450 merges into the seat portion 140. Referring to FIG. 12, the side indentations 470, 480 of the cycling saddle 400 may be disposed along the outer edges 175, 185 of the top surface 130 from the back ridge 147 at the rearward end 120 to a position proximate to the saddle inflection 144 and the front slope 143.

In some examples the cycling saddle 400 according to FIGS. 11-12 optionally may be configured as a saddle core 402 disposed between the bottom surface 200 and the top surface 130. In the present example, the saddle core 402 may be made of any material capable of absorbing shock caused by downward force by an operator seated on the cycling saddle 400. In this regard, the saddle core 402 is configured to provide a shock-absorbing layer while maintaining the contours of the seat portion 140 (for example, as a concave seat portion), the tapered longitudinal depression 450, and the side depressions 470, 480 described above. By way of example only, the saddle core 402 may be formed of a dense foam material. For example, the saddle core 402 may comprise a polyurethane having a density such as from about 3 lb/ft³ to about 10 lb/ft³, or about 5 lb/ft³.

In some examples, the cycling saddle 400 optionally may include a lower shell (not shown) disposed between the bottom surface 200 and the saddle core 402. The lower shell may be formed of a rigid or semi-rigid material suitable to support the saddle core 402 such that the cycling saddle 400 is operable to sustain impacts and/or vibrations generated by an operator seated on the top surface 130 of the cycling saddle 400. By way of example only, the lower shell may comprise a polymer or plastic material. For example, the lower shell may comprise a high-density polyethylene (HDPE) or carbon fiber.

Although not shown, it should be understood that a padding layer may be positioned on the top surface 130 to provide further cushioning, comfort and relief to the pressure points of an operator seated on the cycling saddle 400. By way of example only, the padding layer may be formed of a thin layer of gel and may be sized from approximately 1 mm to approximately 10 mm. Additionally, the cycling saddle 400 optionally may include a covering layer (not shown) in some examples that surrounds all, or a portion, of the saddle core 402. The covering layer comprises a wrapping and/or covering that is configured to be durable to thereby shield and protect the saddle core 402, the lower shell, and/or the padding layer. By way of example only, the covering layer may be formed of leather, faux leather, vinyl, and lycra. The cycling saddle 400 may be a pre-fabricated piece that is formed by molding, 3D-printing, or injection molding. Similarly, the cycling saddle 100 may include any combination of a saddle core, lower shell, padding layer, and/or covering layer as will be suitable.

Further embodiments of this disclosure include a vehicle to which the cycling saddle 100 or the cycling saddle 400, according to any embodiment previously described, is mounted or attached for the purpose of providing a seat for an operator of the vehicle. Example vehicles include bicycles, unicycles, or tricycles, or any other vehicle that is propelled by an ffort from the operator such as pedaling, for example.

Unless otherwise defined, all technical and scientific terms used herein have the same meaning as commonly understood by one of ordinary skill in the art. The terminology used in the description herein is for describing particular embodiments only and is not intended to be limiting. As used in the specification and appended claims, the singular forms “a,” “an,” and “the” are intended to include the plural forms as well, unless the context clearly indicates otherwise.

Unless otherwise indicated, all numbers expressing quantities or properties as used in the specification and claims are to be understood as being modified in all instances by the term “about.” Accordingly, unless otherwise indicated, the numerical properties set forth in the specification and claims are approximations that may vary depending on the desired properties sought to be obtained. One of ordinary skill in the art will understand that any numerical values inherently contain certain errors attributable to the measurement techniques used to ascertain the values.

It should be apparent that modifications and variations to the embodiments described in this specification are possible without departing from the intended scope of this disclosure. More specifically, although some aspects or embodiments may be identified herein as preferred or particularly advantageous, it is not intended that the present disclosure be limited to these preferred aspects or embodiments.

What is claimed is:

1. A cycling saddle comprising:
an elongated front portion between a forward end of the cycling saddle and a saddle inflection of the cycling saddle;
a seat portion between the saddle inflection and a rearward end of the cycling saddle opposite the forward end; and
a pair of individual side indentations defined in a top surface of the cycling saddle and laterally offset within the seat portion on opposite sides of the seat portion, the individual side indentations being configured to accommodate ischial tuberosities of an operator positioned on the top surface.

2. The cycling saddle of claim 1, wherein the seat portion is concave, the top surface of the cycling saddle within the seat portion being depressed relative to the elongated front portion and the rearward end such that the top surface includes a front slope descending from the saddle inflection toward the rearward end and a rear slope descending from the rearward end toward the front slope.

3. The cycling saddle of claim 2, wherein an intersection of the elongated front portion and the front slope of the seat portion at the saddle inflection defines an angle of about 5 degrees to about 20 degrees.

4. The cycling saddle of claim 2, wherein an intersection of the elongated front portion and the front slope of the seat portion at the saddle inflection defines an angle of about 5 degrees to about 10 degrees.

5. The cycling saddle of claim 1, wherein the individual side indentations are ovoid depressions sized and shaped to receive the ischial tuberosities the operator positioned on the top surface.

6. The cycling saddle of claim 1, wherein the individual side indentations are configured as valleys or grooves along the outer edges of the top surface from the rearward end toward the saddle inflection and are sized and shaped to receive the ischial tuberosities an operator positioned on the top surface.

7. The cycling saddle of claim 1, wherein the individual side indentations are ovoid depressions configured to encircle the ischial tuberosities of the operator and distribute a downward force from the operator at the ischial tuberosities to alleviate pressure points on the ischial tuberosities.

8. The cycling saddle of claim 1, wherein the top surface has a longitudinal depression defined therein.

9. The cycling saddle of claim 1, wherein the top surface has a longitudinal depression defined therein from the elongated front portion to the rear slope.

10. The cycling saddle of claim 1, further comprising a rail support system, configured to couple the cycling saddle to a framing member of a vehicle.

11. The cycling saddle of claim 10, wherein the vehicle is a bicycle.

12. A cycling saddle comprising:
an elongated front portion between a forward end of the cycling saddle and a saddle inflection of the cycling saddle;
a concave seat portion between the saddle inflection and a rearward end of the cycling saddle opposite the forward end;
a pair of individual side indentations defined in the top surface and laterally offset within the concave seat portion on opposite sides of the concave seat portion; and
a longitudinal depression defined in the top surface from the elongated front portion to the rear slope.

13. The cycling saddle of claim 12, wherein the individual side indentations are ovoid depressions sized and shaped to receive the ischial tuberosities of an operator positioned on the top surface.

14. The cycling saddle of claim 13, wherein an intersection of the elongated front portion and the front slope of the concave seat portion at the saddle inflection defines an angle of about 5 degrees to about 20 degrees.

15. The cycling saddle of claim 12, wherein the individual side indentations are configured as valleys or grooves along the outer edges of the top surface from the rearward end toward the saddle inflection and are sized and shaped to receive the ischial tuberosities an operator positioned on the top surface.

16. A cycling saddle comprising:
an elongated front portion between a forward end of the cycling saddle and a saddle inflection of the cycling saddle;
a concave seat portion between the saddle inflection and a rearward end of the cycling saddle opposite the forward end, a top surface of the cycling saddle within the concave seat portion being depressed relative to the elongated front portion and the rearward end such that the top surface includes a front slope descending from the saddle inflection toward the rearward end and a rear slope descending from the rearward end toward the front slope, wherein an intersection of the elongated front portion and the front slope of the concave seat portion at the saddle inflection defines an angle of about 5 degrees to about 20 degrees;
a pair of individual side indentations defined in the top surface and laterally offset within the concave seat portion on opposite sides of the concave seat portion, the individual side indentations being ovoid depressions sized and shaped to receive the ischial tuberosities an operator positioned on the top surface; and
a longitudinal depression defined in the top surface from the elongated front portion to the rear slope.

17. The cycling saddle of claim 16, wherein the elongated front portion adjacent to the forward end comprises a downward tilt relative to the remainder of the elongated front portion extending from the saddle inflection.

18. The cycling saddle of claim 17, wherein the downward tilt is from about 5 degrees to about 25 degrees.

19. The cycling saddle of claim 16, further comprising a rail support system, configured to couple the cycling saddle to a framing member of a vehicle.

20. The cycling saddle of claim 19, wherein the vehicle is a bicycle.
